(19) United States
(12) Patent Application Publication
(10) Pub. No.: US 2018/0025224 A1
(43) Pub. Date: Jan. 25, 2018

(54) SYSTEM AND METHOD FOR IDENTIFYING UNCLAIMED ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/669,224

(22) Filed: Aug. 4, 2017

Related U.S. Application Data
(63) Continuation-in-part of application No. 15/361,934, filed on Nov. 28, 2016.
(60) Provisional application No. 62/371,771, filed on Aug. 7, 2016.
(60) Provisional application No. 62/260,553, filed on Nov. 29, 2015.
(60) Provisional application No. 62/261,355, filed on Dec. 1, 2015.

(51) Int. Cl. G06K 9/00; G06F 17/30

(52) U.S. Cl. CPC G06K 9/00469; G06K 9/00483; G06F 17/30011; G06K 2209/01

(57) ABSTRACT

A system and method for identifying unclaimed electronic documents among at least one electronic document, each electronic document including at least partially unstructured data. The method includes: analyzing each electronic document to determine at least one transaction parameter of the electronic document; creating a template for each electronic document, wherein each template is a structured dataset including the at least one transaction parameter determined for the electronic document; and determining whether each electronic document is unclaimed, wherein determining whether an electronic document is unclaimed further comprises comparing at least a portion of the template created for the electronic document to identifying data of a plurality of previous reclaims.

### CROSS-REFERENCE TO RELATED APPLICATIONS

This application claims the benefit of U.S. Provisional Application No. 62/371,771 filed on Aug. 7, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to analyzing electronic documents, and more particularly to identifying unclaimed electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

The value-added tax, or VAT, is a broadly-based consumption tax applied to goods and services purchased in some countries. VATs paid abroad may be reclaimed by submitting a VAT reclaim request along with evidence of the purchase. Many companies have employees purchase goods and services that may be subject to VATs and, therefore, seek to reclaim those VATs. However, for various reasons, VATs may go unclaimed. For example, employees may not be sufficiently motivated to apply for reclaims at the airport, or companies may be concerned about punishments for accidentally submitting requests for reclaiming duplicate VATs (i.e., two different requests seeking to reclaim VATs paid on the same transaction).

Thus, although VATs may be reclaimed retroactively, they are nevertheless typically not ultimately reclaimed. Some solutions exist for collecting data related to VAT transactions, but such solutions face challenges in analyzing and collecting data from unstructured electronic documents such as images showing scanned receipts.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for identifying unclaimed electronic documents among at least one electronic document, each electronic document including at least partially unstructured data. The method comprises: analyzing each electronic document to determine at least one transaction parameter of the electronic document; creating a template for each electronic document, wherein each template is a structured dataset including the at least one transaction parameter determined for the electronic document; and determining whether each electronic document is unclaimed, wherein determining whether an electronic document is unclaimed further comprises comparing at least a portion of the template created for the electronic document to identifying data of a plurality of previous reclaims.

Certain embodiments disclosed herein also include a non-transitory computer readable medium having stored thereon instructions for causing a processing circuitry to perform a process for identifying unclaimed electronic documents among at least one electronic document, each electronic document including at least partially unstructured data the process comprising: analyzing each electronic document to determine at least one transaction parameter of the electronic document; creating a template for each electronic document, wherein each template is a structured dataset including the at least one transaction parameter determined for the electronic document; and determining whether each electronic document is unclaimed, wherein determining whether an electronic document is unclaimed further comprises comparing at least a portion of the template created for the electronic document to identifying data of a plurality of previous reclaims.

Certain embodiments disclosed herein also include a system for identifying unclaimed electronic documents among at least one electronic document, each electronic document including at least partially unstructured data. The system comprises: a processing circuitry; and a memory, the memory containing instructions that, when executed by the processing circuitry, configure the system to: analyze each electronic document to determine at least one transaction parameter of the electronic document; create a template for each electronic document, wherein each template is a structured dataset including the at least one transaction parameter determined for the electronic document; and determine whether each electronic document is unclaimed, wherein determining whether an electronic document is unclaimed further comprises comparing at least a portion of the template created for the electronic document to identifying data of a plurality of previous reclaims.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for identifying unclaimed electronic documents according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for identifying unclaimed electronic documents. In an embodiment, datasets are created based on electronic documents. A template of transaction attributes is created based on each dataset. Based on the created templates and data of previously reclaims, it is determined whether each electronic document is an unclaimed electronic document indicating an unclaimed transaction. When it is determined that an electronic document is unclaimed, a certainty score may be determined based on the template created for the electronic document and templates of the reclaimed electronic documents. An electronic reclaim document may be generated for each electronic document having a certainty score above a threshold.

The disclosed embodiments allow for unclaimed electronic documents illustrating, for example, evidence of transactions. More specifically, the disclosed embodiments include providing structured dataset templates for electronic documents, thereby allowing for more accurately identifying unclaimed electronic documents that are unstructured, semi-structured, or otherwise lacking a known structure. For example, image files showing invoices that were not previously submitted for reclaim may be determined from among a group of image files showing invoices.

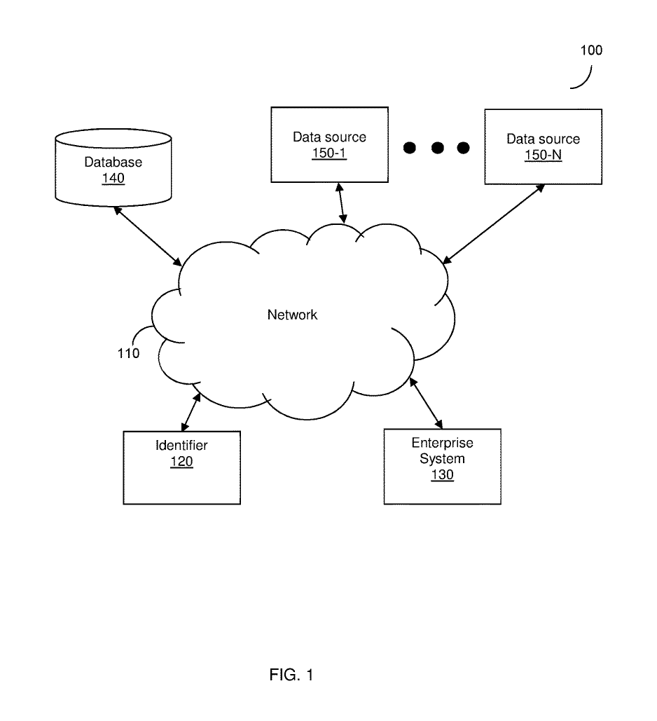

FIG. 1 shows an example network diagram 100 utilized to describe the various disclosed embodiments. In the example network diagram 100, an unclaimed electronic document identifier 120, an enterprise system 130, a database 140, and a plurality of data sources 150-1 through 150-N (hereinafter referred to individually as a data source 150 and collectively as data sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.). Each electronic document may show, e.g., an evidence of a transaction such as an invoice, a tax receipt, a purchase number record, and the like. Data included in each electronic document may be structured, semi-structured, unstructured, or a combination thereof. The structured or semi-structured data may be in a format that is not recognized by the identifier 120 and, therefore, may be treated as unstructured data. In some implementations, at least some of the electronic documents may be received or retrieved from one or more client devices (not shown) associated with the enterprise.

The database 140 may store electronic reclaim documents generated by the identifier 120. The data sources 150 store at least data of previously VAT reclaims. The data sources 150 may include, but are not limited to, servers or devices of merchants, tax authority servers, accounting servers, a database associated with an enterprise, and the like. The data of the previous reclaims may include unstructured electronic documents (e.g., the previously reclaimed electronic documents), or other data indicating parameters of the transactions for which reclaims have been obtained.

In an embodiment, the identifier 120 is configured to create templates based on transaction parameters identified using machine vision electronic documents. Each electronic document indicates information related to a transaction. In a further embodiment, the identifier 120 may be configured to retrieve the electronic documents from, e.g., the enterprise system 130.

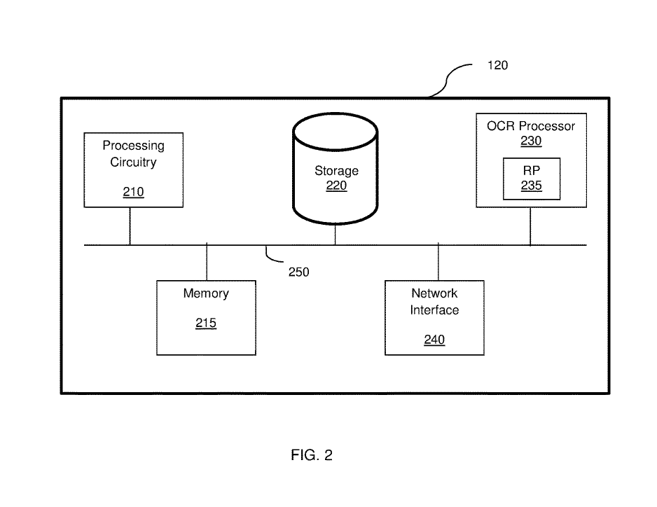

To this end, an embodiment, the identifier 120 is configured to create datasets based on electronic documents including data at least partially lacking a known structure (e.g., unstructured data, semi-structured data, or structured data having an unknown structure). The identifier 120 may be further configured to utilize optical character recognition (OCR) or other image processing to determine data in the electronic document. The identifier 120 may therefore include or be communicatively connected to a recognition processor (e.g., the recognition processor 235, FIG. 2).

In an embodiment, the identifier 120 is configured to analyze the created datasets to identify transaction parameters related to transactions indicated in the electronic documents and to create a template based on each created dataset for an electronic document. Each template is a structured dataset including the identified transaction parameters for a transaction. More specifically, each template may include a data element in each field, where each transaction parameter is a value of the data element.

Using structured templates for completing electronic documents allows for more efficient and accurate identification of unclaimed electronic documents than, for example, by utilizing unstructured data. Specifically, data of previous reclaims may be compared to data of the electronic documents with respect to fields of the structured templates. Further certainty scores indicating likelihood that reclaims will be successful may be determined with respect to data in specific fields of the templates.

In an embodiment, based on the created templates, the identifier 120 is configured to determine whether any of the electronic documents are unclaimed. An electronic document may be unclaimed when a set of uniquely identifying transaction parameters of the electronic document (e.g., as indicated in the created template for the electronic document) do not match any sets of uniquely identifying transaction parameters of a previous reclaim, or do not match above a predetermined threshold. As a non-limiting example, an electronic document indicating a payment of 200 Euros made by an employee John Smith on Jul. 25, 2016, may be unclaimed when no previous reclaim was based on a transaction having a price of 200 Euros made by John Smith on Jul. 25, 2016. As another non-limiting example, an electronic document indicating a transaction identifier of “123456” may be unclaimed when no previous reclaim was based on an electronic document including a transaction identifier of “123456.”

In an embodiment, the identifier 120 is configured to determine a certainty score for each unclaimed electronic document. Each certainty score indicates a likelihood that a reclaim requested based on the electronic document will be successful. The certainty scores may be determined by comparing data of the created templates to data of previous reclaims. More specifically, the certainty scores may be determined with respect transaction parameters such as, for example, date of transaction, description of goods or services purchased, and the like. For example, a certainty score may be determined for an unclaimed invoice for a transaction made in January 2015 for a purchase of a hotel stay with respect to 100 previously reclaimed electronic documents made in January 2015. As a non-limiting example, if only 2 out of 10 previously reclaimed electronic documents related to purchases of hotel stays were successfully reclaimed, a certainty score of 0.1 may be determined.

In an embodiment, the identifier 120 is configured to compare each certainty score to a predetermined certainty threshold. For each electronic document having a certainty score above the certainty threshold, the identifier 120 may be configured to determine that the electronic document should have been reclaimed and, accordingly, may be configured to generate an electronic reclaim document based on the template for the electronic document. The generated electronic reclaim documents and corresponding unclaimed electronic documents may be sent to, for example, one of the data sources 150 (e.g., a server of a tax authority).

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the identifier 120 according to an embodiment. The identifier 120 includes a processing circuitry 210 coupled to a memory 215, a storage 220, and a network interface 240. In an embodiment, the identifier 120 may include an optical character recognition (OCR) processor 230. In another embodiment, the components of the identifier 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to complete electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the identifier 120 to communicate with the enterprise system 130, the database 140, the data sources 150, or a combination of, for the purpose of, for example, collecting metadata, retrieving data, storing data, and the like.

It should be understood that the embodiments described herein are not limited to the specific architecture illustrated in FIG. 2, and other architectures may be equally used without departing from the scope of the disclosed embodiments.

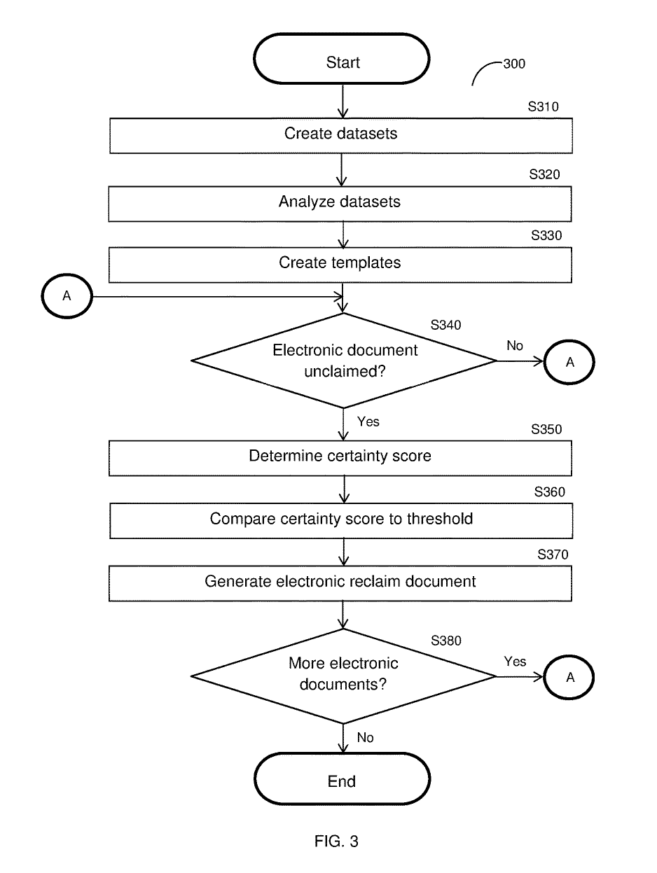

FIG. 3 is an example flowchart 300 illustrating a method for completing an electronic document according to an embodiment. In an embodiment, the method may be performed by an unclaimed electronic document identifier (e.g., the identifier 120). In an example implementation, the electronic document may be an electronic receipt (e.g., an image showing a scanned receipt).

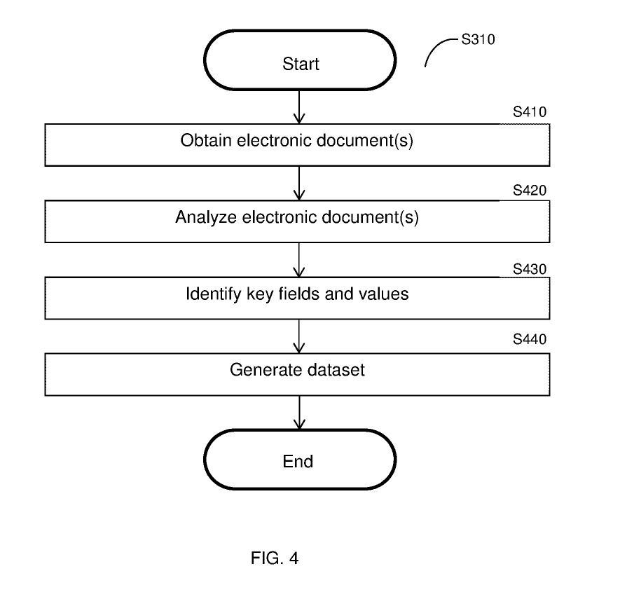

At S310, datasets are created based on electronic documents including information related to transactions. The electronic documents may include, but is not limited to, unstructured data, semi-structured data, structured data with structure that is unanticipated or unannounced, or a combination thereof. In an embodiment, S310 may further include analyzing each electronic document using optical character recognition (OCR) to determine data in the electronic document, identifying key fields in the data, identifying values in the data, or a combination thereof. Creating datasets based on electronic documents is described further herein below with respect to FIG. 4.

At S320, the created datasets are analyzed. In an embodiment, analyzing each dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing each dataset may also include identifying the transaction based on the dataset.

At S330, a template is created based on each dataset. Each template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, identifying incomplete date elements in structured templates may result in more accurate identification of incomplete data elements based on unstructured data. Additionally, searching for complementary data based on incomplete data elements identified in structured templates may be performed with respect to fields of the templates, thereby more accurately identifying complementary data.

At S340, based on the created template for one of the electronic documents, it is determined whether the electronic document is unclaimed and, if so, execution continues with S350; otherwise, execution may continue with S340 and a new electronic document is analyzed. Execution may continue until it is determined whether each electronic document is unclaimed.

In an embodiment, S340 includes comparing data of the template for the electronic document to data associated with previous reclaims. Based on the comparison, it may be determined whether the transaction indicated in the electronic document matches any of the previously reclaimed transactions. To this end, the comparison may include comparing one or more uniquely identifying transaction parameters for the electronic document to transaction parameters associated with each of the previous reclaims, where an electronic document is unclaimed when identifying transaction parameters of the electronic document do not match identifying transaction parameters of any of the previous reclaims. In some implementations, a template may be created for an electronic document associated with each previous reclaim, and values in one or more fields of the unclaimed electronic document template may be compared to values in corresponding fields of each previous reclaim template.

At S350, when it is determined that an electronic document is unclaimed, a certainty score is determined for the electronic document. The certainty score indicates a likelihood that the unclaimed electronic document can be successfully reclaimed, and may be determined based on the unclaimed electronic document and data of previous reclaims. The certainty score may be determined based on one or more transaction parameters that are common to the unclaimed electronic document and one or more of the previous reclaims. The certainty score may be determined based further on the number of previous reclaims sharing common transaction parameters, the total number of previous reclaims, or both. As a non-limiting example, a certainty score of 7 may be determined an unclaimed electronic document indicating the same time period and expense description as multiple previous reclaims among 30 previous reclaims.

At S360, the certainty score for the electronic document is compared to a predetermined certainty threshold. The certainty threshold may establish a minimum certainty score that indicates that an electronic document should be reclaimed.

At S370, when the certainty score is above the certainty threshold, an electronic reclaim document is generated for the electronic document. The electronic reclaim document may include the unclaimed electronic document and may indicate a request for a reclaim. The electronic reclaim document may further include one or more required transaction parameters for reclaiming VATs paid for the transaction indicated in the electronic document.

At S380, it is checked whether additional electronic documents are to be processed and, if so, execution continues with S340; otherwise, execution terminates.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identifying unclaimed electronic documents among at least one electronic document, each electronic document including at least partially unstructured data, comprising:
analyzing each electronic document to determine at least one transaction parameter of the electronic document;
creating a template for each electronic document, wherein each template is a structured dataset including the at least one transaction parameter determined for the electronic document; and
determining whether each electronic document is unclaimed, wherein determining whether an electronic document is unclaimed further comprises comparing at least a portion of the template created for the electronic document to identifying data of a plurality of previous reclaims.

2. The method of claim 1, wherein determining the at least one transaction parameter of each electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the electronic document further comprises:
performing optical character recognition on the electronic document.

5. The method of claim 1, further comprising:
determining, for each unclaimed electronic document, a certainty score, wherein each certainty score indicates a likelihood that the unclaimed electronic document can be successfully reclaimed;
comparing each certainty score to a predetermined certainty threshold; and
generating an electronic reclaim document for each unclaimed electronic document having a certainty score above the certainty threshold.

6. The method of claim 1, wherein a set of identifying transaction parameters of each unclaimed electronic document does not match a set of identifying transaction parameters of any of the plurality of previous reclaims.

7. A non-transitory computer readable medium having stored thereon instructions for causing a processing circuitry to perform a process for identifying unclaimed electronic documents among at least one electronic document, each electronic document including at least partially unstructured data, the process comprising:
analyzing each electronic document to determine at least one transaction parameter of the electronic document;
creating a template for each electronic document, wherein each template is a structured dataset including the at least one transaction parameter determined for the electronic document; and
determining whether each electronic document is unclaimed, wherein determining whether an electronic document is unclaimed further comprises comparing at least a portion of the template created for the electronic document to identifying data of a plurality of previous reclaims.

8. A system for identifying unclaimed electronic documents among at least one electronic document, each electronic document including at least partially unstructured data, comprising:
a processing circuitry; and
a memory, the memory containing instructions that, when executed by the processing circuitry, configure the system to:
analyze each electronic document to determine at least one transaction parameter of the electronic document;
create a template for each electronic document, wherein each template is a structured dataset including the at least one transaction parameter determined for the electronic document; and
determine whether each electronic document is unclaimed, wherein determining whether an electronic document is unclaimed further comprises comparing at least a portion of the template created for the electronic document to identifying data of a plurality of previous reclaims.

9. The method of claim 8, wherein the system is further configured to:
identify, in each electronic document, at least one key field and at least one value;
creating, based on each electronic document, a dataset, wherein the created dataset includes the at least one key field and the at least one value identified in the electronic document; and
analyzing each created dataset, wherein the at least one transaction parameter of each electronic document is determined based on the analysis.

10. The system of claim 9, wherein the system is further configured to:
analyzing each electronic document to determine data in the electronic document; and
extracting, based on a predetermined list of key fields, at least a portion of the determined data for each electronic document, wherein the at least a portion of the determined data matches at least one key field of the predetermined list of key fields.

11. The system of claim 10, wherein the system is further configured to perform optical character recognition on each electronic document.

12. The system of claim 8, wherein the system is further configured to:
determine, for each unclaimed electronic document, a certainty score, wherein each certainty score indicates a likelihood that the unclaimed electronic document can be successfully reclaimed;
compare each certainty score to a predetermined certainty threshold; and
generate an electronic reclaim document for each unclaimed electronic document having a certainty score above the certainty threshold.

13. The system of claim 8, wherein a set of identifying transaction parameters of each unclaimed electronic document does not match a set of identifying transaction parameters of any of the plurality of previous reclaims.
